(19) United States
(12) Patent Application Publication
(10) Pub. No.: US 2024/0363260 A1
(43) Pub. Date: Oct. 31, 2024

(54) METHOD FOR CONTROLLING METAL DISSOLUTION USING AN ELECTRICAL CURRENT

(71) Applicant: BATTELLE SAVANNAH RIVER ALLIANCE, LLC, AIKEN, SC (US)

(72) Inventors: WILLIAM E. DANIEL, JR., NORTH AUGUSTA, SC (US); JARROD M. GOGOLSKI, NORTH AUGUSTA, SC (US); DANIEL J. FOLEY, WARRENVILLE, SC (US); RODERICK E. FUENTES, AIKEN, SC (US)

(21) Appl. No.: 18/306,375

(22) Filed: Apr. 25, 2023

(51) Int. Cl. G21F 9/30; C25F 3/04; C25F 5/00

(52) U.S. Cl. CPC G21F 9/30; C25F 3/04; C25F 5/00

(57) ABSTRACT

A process for dissolving a metal in an electrolytic acid medium using a catalyst. The process comprises applying a negative electrical current to the metal while the electrolytic acid medium is at a temperature below its boiling point to initiate a dissolution reaction, stopping the application of the electrical current, and allowing heat from the reaction to raise the temperature of the solution without the application of any external heat source.

### STATEMENT REGARDING FEDERALLY SPONSORED RESEARCH OR DEVELOPMENT

This invention was made with government support under Contract No. 89303321CEM000080, awarded by the U.S. Department of Energy. The government has certain rights in the invention.

### BACKGROUND

A unique characteristic of nuclear energy is that used fuel may be separated from other components and reused as new fuel. For instance, the fissionable materials contained in a spent rod from a nuclear power plant can be reprocessed and reused in new fuel rods. Practically all nuclear materials, including uranium and plutonium, can be reprocessed in this manner.

Fuel elements, including fuel rods in nuclear reactors, become unusable not so much on account of actual depletion of the fissionable fuel values, but because of the accumulation within the element of fission products. These fission products can interfere with the neutron flux within the reactor. Consequently, fuel elements are withdrawn from the reactor long before the fuel values are anywhere near to being completely consumed. The withdrawn or used nuclear fuel (sometimes referred to as spent fuel rods) have significant fuel value. At the same time, it is desirable to recover the valuable by-products of reactor operation, the transmutation products such as plutonium, which is a fissionable fuel, and certain isotopes of the fission products which are useful in many different fields and have multifarious applications.

Many research reactor fuel assemblies or fuel plates contain a nuclear material in combination with aluminum, such as a uranium-aluminum alloy or a uranium aluminide dispersed in a continuous aluminum phase. Aluminum is also widely used as a fuel element cladding material because it has a relatively low neutron absorption cross-section, is corrosion resistant, and has favorable thermal properties. One type of aluminum used as a cladding material includes 1100 aluminum. Other alloys include 6061 and 6063.

A conventional process for recovering nuclear materials from used nuclear fuel is a dissolution process during which the aluminum material is dissolved. One conventional process for recovering fissionable materials is an aqueous process during which the fuel elements are dissolved in an acidic solution (e.g., nitric acid). The surface of aluminum forms a protective oxide layer in nitric acid that can be removed by either using a catalyst like mercury at the solution's boiling point or by applying a sufficient current in an electrolytic dissolver to break through the aluminum oxide layer.

In this regard, fuel elements containing an aluminum-uranium alloy contained in aluminum cladding, for instance, may be dissolved in a mercury-catalyzed, nitric acid solution. Alternatively, in a separate conventional process, the aluminum alloy can be dissolved electrolytically in an electrolytic dissolver (e.g., by a solution contact process or a metal contact process). After the fuel is dissolved in the solution, the uranium can be recovered from the aluminum and fission products.

As the mercury catalyzed dissolution process is most effective at the solution's boiling point, a large amount of heating energy is required to bring the solution to boiling. For example, typical dissolutions of aluminum from spent reactor fuels are performed using from about 7000-14000 L of nitric acid. Heating such a large amount of acid to boiling is very costly and energy intensive.

In view of the above, a need exists for a method or technique for dissolving aluminum in a catalyzed acid solution without having to heat the solution to boiling using an external heat source.

### SUMMARY

In one embodiment, the present disclosure is directed to a process for dissolving a metal in an electrolytic acid medium using a catalyst. The process comprises applying a negative electrical current to the metal while the electrolytic acid medium is at a temperature below its boiling point to initiate a dissolution reaction, stopping the application of the electrical current, and allowing heat from the reaction to raise the temperature of the solution without the application of any external heat source.

In another embodiment, the present disclosure is directed to a process for dissolving aluminum comprising immersing the aluminum in a nitric acid solution containing greater than 0.001 M mercury and applying an electrical current between the aluminum and a counter-electrode in the solution.

In yet another embodiment, the present disclosure is directed to a process for dissolving aluminum during the recovery of a nuclear fuel. The process comprises immersing a material containing aluminum and a nuclear fuel in a nitric acid solution containing a catalyst, such as mercury, applying a negative electrical current to the material containing aluminum and a nuclear fuel while the temperature of the solution is below its boiling point, stopping the application of the electrical current, and allowing heat from the reaction to raise the temperature of the solution to its boiling point without the application of any external heat source.

Other features and aspects of the present disclosure are discussed in greater detail below.

### BRIEF DESCRIPTION OF THE FIGURES

A full and enabling disclosure of the present invention, including the best mode thereof to one skilled in the art, is set forth more particularly in the remainder of the specification, including reference to the accompanying figures, in which:

FIG. 1 is a schematic diagram of a dissolution reaction system in accordance with the present disclosure.

### DETAILED DESCRIPTION

It is to be understood by one of ordinary skill in the art that the present discussion is a description of exemplary embodiments only, and is not intended as limiting the broader aspects of the present disclosure.

In general, the present disclosure is directed to a process for controlling the dissolution rate of a metal (e.g., aluminum) in a dissolution solution. In one embodiment, for instance, the metal may comprise aluminum that is being dissolved in a metal (e.g., mercury) catalyzed acid medium. As will be explained in detail below, the method of the present disclosure can be used to initiate an autocatalytic reaction by applying a negative electrical current to the metal. Although the teachings of the present disclosure can be used in numerous and diverse applications, in one embodiment, the method of the present disclosure is used to initiate a dissolution reaction used to recycle a used nuclear fuel, such as such as during the reprocessing of spent fuel elements or fuel rods.

Research reactor fuel assemblies or fuel plates are typically comprised of an aluminum cladding surrounding a nuclear fuel. The nuclear fuel may comprise uranium, plutonium, and mixtures thereof. In one embodiment, the fuel assembly or fuel plate contains an aluminum-uranium alloy or uranium aluminide dispersed in a continuous aluminum phase surrounded by an aluminum cladding. Spent fuel assemblies or fuel plates still contain a significant amount of reusable nuclear fuel. In order to reuse and recycle the nuclear fuel (e.g., uranium contained in a fuel rod), in one embodiment, the aluminum is dissolved in an acid in the presence of a catalyst which allows the nuclear fuel to be separated from the aluminum.

In one embodiment, for instance, the recovery of fissionable materials comprises the dissolution of fuel assemblies in a dissolution solution. The dissolution solution contains an electrolytic acid medium that is comprised of an acid and a catalyst. One or more fuel assemblies are lowered into the medium and the temperature of the solution is elevated. In one embodiment, the acid bath contains nitric acid with a mercury catalyst to dissolve the aluminum/uranium and allow recovery of the uranium from the aluminum and fission products.

In conventional mercury catalyzed dissolution processes, large quantities of acid need to be heated to boiling by an external heat source to achieve an effective reaction. In accordance with the present disclosure, however, it was discovered that the reaction can be initiated at a temperature below the solution's boiling point (e.g., at ambient temperature) by applying a negative current to the metal. Once the reaction is initiated by the application of the current, the application of the current can be stopped, and the solution can proceed to boiling due to the exothermic nature of the reaction and remain there until the dissolution is complete.

In accordance with the present disclosure, the metal dissolution process is initiated by applying a negative charge to the metal (e.g., aluminum). Previously known, the mercury forms a Hg—Al amalgam by reducing on the aluminum surface at boiling temperatures that then readily dissolves into the nitric acid. The freed mercury ions then go back to the aluminum surface and repeat the process. Without wishing to be bound by theory, it is believed that when the charge of the aluminum surface is manipulated with a negative current, the mercury is encouraged to reduce onto the Al surface. An applied negative current sets up a negative charge on the aluminum surface which further lowers the activation energy for mercury to form the Hg—Al amalgam, that was otherwise previously provided in an exothermic (i.e., boiling) solution. As such, the reaction can proceed and accelerate even when initiated at relatively low temperatures.

In one embodiment, aluminum is dissolved in a dissolution solution containing an acid, such as nitric acid, and a catalyst, such as a mercury. During the process by which the aluminum is dissolved, mercury ions having a +2 valence are reduced to a zero valence by the aluminum surface. An amalgamation of the aluminum with the mercury then occurs. The mercury-aluminum amalgam is subsequently oxidized by the nitric acid, which dissolves the aluminum and regenerates the mercury ions into the +2 valence state. In accordance with the present disclosure, by applying a negative charge to the aluminum, the mercury ions are attracted to the surface of the aluminum to initiate this reaction.

The negative charge can be applied to the metal in any manner known in the art. For example, in some embodiments, the metal can be connected to a direct current source (e.g., a battery). It can be connected to the current source via a wire attached to the metal or by contacting the metal with an electrode connected to the current source. Additionally, a counter electrode (e.g., a graphite rod) can be placed in the electrolytic acid medium.

The counter electrode may comprise different and various types of materials. In one embodiment, the counter electrode is comprised of a material capable of forming a galvanic couple with the metal being dissolved, such as aluminum. In one embodiment, for instance, the counter electrode may be comprised of a material that does not dissolve in the dissolution solution, which may comprise heated nitric acid. In this regard, the counter electrode is preferably made from a material that does not adversely interfere with the process or lead to any unwanted contaminants. In one embodiment, the counter electrode may comprise graphite. In an alternative embodiment, the counter electrode may comprise a metallic material.

When the counter electrode comprises a conductive material, various different types of conductors may be used. For instance, the counter electrode may comprise gold, platinum, titanium, a stainless-steel alloy, a nickel-copper alloy, a nickel-chromium alloy, graphite, or mixtures thereof.

The counter electrode can also be electrically connected to the direct current source. As such, when a current is applied via the direct current source, the metal (e.g., aluminum) acts as a cathode and the counter electrode acts as an anode. As such, a negative charge is applied to the metal to initiate the dissolution reaction.

Although the steps of the process can be performed in any suitable order, in one embodiment, a vessel (i.e., reactor) is first filled with the acid and the catalyst is then added to the acid. The metal is then immersed in the solution (i.e., electrolytic acid medium) while being electrically connected to the current source. The counter electrode is then immersed in the solution and a negative charge is applied to the metal to initiate the dissolution reaction. After a relatively short period of time, the application of the current can be stopped and the reaction can proceed toward completion on its own, the solution increasing in temperature until it reaches boiling. The reaction then proceeds in the conventional manner and can be controlled by means known in the art.

By the method disclosed herein, the dissolution reaction can be initiated at a temperature well below the boiling point of the solution, such as at a temperature of about 50° C. or less or even about 30° C. or less.

Advantageously, the electrical current only needs to be applied for a short period of time to initiate the reaction. For example, the present inventors surprisingly discovered that, even when the electrolytic acid medium is at room temperature, the autocatalytic reaction can be initiated through the application of the current for about 10 min or less, in some embodiments 5 min or less, and in some embodiments, 3 min or less. The current is typically applied for more than about 5 seconds or longer, in some embodiments about 30 seconds or longer, in some embodiments about 1 minute or longer, and in some embodiments, about 2 minutes or longer.

The equipment used in the process is not limited. However, in one embodiment, the vessel is an industrial size vessel configured to hold from about 7,000 to about 14,000 L of acid, a wire is attached to the spent nuclear fuel containing aluminum to connect it to the direct current source, and a graphite rod is used as the counter electrode.

In another embodiment, an electrolytic dissolver of any type known in the art can be used. However, rather than operating the electrolytic dissolver as usual, the electrolytic solution contains a catalyst and the electrical charge is only applied for a brief period of time, such as described above, before allowing the autocatalytic reaction to proceed on its own.

As described above, the method of the present disclosure is particularly well suited for controlling the dissolution of aluminum when reprocessing fuel assemblies or spent fuel plates. In order to reprocess spent fuel assemblies, for instance, the fuel assemblies are typically suspended above and gradually lowered into an electrolytic acid medium including the acid and the catalyst. The acid may comprise heated nitric acid in combination with a mercury catalyst. The electrolytic acid medium dissolves the aluminum so that the aluminum can be separated from the nuclear fuel, which may comprise uranium.

The amount of catalyst contained in the dissolution solution generally depends upon the concentration of acid and/or the amount of aluminum that needs to be dissolved. In general, the catalyst, such as mercury, is present in the dissolution solution in an amount greater than about 0.0005 molar, such as greater than about 0.001 molar, such as greater than about 0.0015 molar. The catalyst concentration is generally less than about 0.1 molar, such as less than about 0.01 molar, such as less than about 0.005 molar, such as less than about 0.004 molar, such as less than about 0.003 molar. In some embodiments, for instance, the catalyst concentration is from about 0.0005 molar to about 0.02 molar.

While the process is generally described using a mercury catalyst, it should be understood that other catalysts can also be used. For example, the catalyst can also comprise NaCl, Na₂SO₄, or another catalyst.

The acid present in the dissolution solution comprises any suitable acid capable of dissolving the aluminum in the presence of the catalyst. In one embodiment, nitric acid is used. As aluminum dissolves, the nitric acid is consumed during the process releasing off-gases, such as nitrogen oxides and hydrogen. In one embodiment, as the process proceeds, the molar concentration of nitric acid decreases. In one embodiment, the initial molar concentration of nitric acid in the dissolution solution prior to beginning the process is greater than about 1 molar, such as greater than about 3 molar, such as greater than about 5 molar, such as greater than about 6 molar. The initial nitric acid concentration is generally less than about 16 molar, such as less than about 12 molar, such as less than about 10 molar, such as less than about 9 molar, such as less than about 8 molar. In one embodiment, the initial concentration of the nitric acid is from about 4 molar to about 15 molar and, in some embodiments, from about 5 molar to about 8 molar.

The lowest or final concentration of nitric acid in the dissolution solution can depend upon various factors. In one embodiment, for instance, greater amounts of nitric acid can be added to the solution as the aluminum dissolves. In a batch process, however, the process will continue until virtually all of the aluminum has dissolved. In this embodiment, the final nitric acid concentration can be less than about 2 molar, such as less than about 1.5 molar, such as less than about 1 molar, such as less than about 0.5 molar. During the process, at least 95%, such as at least 96%, such as at least 97%, such as at least 98%, such as even at least 99% of the aluminum is dissolved.

The process is generally described using aluminum as the metal. For example, in one embodiment, the metal comprises aluminum and/or an aluminum alloy, such as an aluminum-uranium alloy or uranium aluminide dispersed in a continuous aluminum phase core surrounded by an aluminum cladding. For instance, the metal can be contained in a spent nuclear fuel assembly. However, other metals can be dissolved by the process as well. For example, any metal forming an oxide layer which can be dissolved by a metal ion catalyzed dissolution reaction can potentially be dissolved by the process described herein. One example of another such metal is nickel.

The present disclosure may be better understood with reference to the following examples.

### Example 1

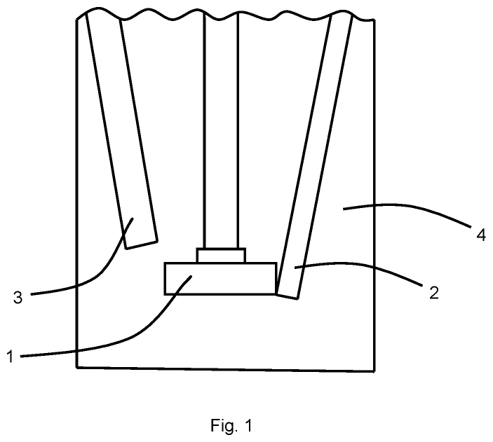

The effect of applying a negative current to aluminum in a solution of 7M nitric acid and 0.002M mercury was demonstrated. FIG. 1 shows a schematic of the reactor setup. As illustrated, an aluminum coupon 1 was immersed in the solution 4 and contacted by an electrode rod 2. A counter electrode rod 3 was also immersed in the solution 4. The electrodes were connected to a potentiostat (not shown) to control the application of the current.

When a negative current was applied to the aluminum coupon, the catalyzed dissolution reaction accelerated from its normal (slow) rate at 70° C., as evidenced by the generation of NOx gases around coupon.

When a positive current was applied to the aluminum coupon in the same solution at 70° C., the reaction rate was much lower than when the negative current was applied to the aluminum. This was evidenced by the relative clarity of the solution compared when applying a negative current due to the lack of gasses generated by the reaction.

### Example 2

The effect of applying a negative current to the aluminum coupon in 7M nitric acid and 0.002 M mercury at 25° C. (room temperature) was demonstrated to show that the autocatalytic Hg dissolution can be initiated without heating to boiling.

The reactor set up was the same as in Example 1. Before applying any current, the dissolution reaction at room temperature (26.2° C.) was very slow. This was indicated by a very clear solution with few, if any, gas bubbles.

After 2 minutes of applying a negative current to the aluminum coupon, the temperature increased slightly to 27.1° C. and there was increased dissolution as indicated by the buildup of gas bubbles around the coupon.

After 2 minutes and 13 seconds of applying a negative current to the aluminum coupon, the temperature increased more rapidly to 28.0° C. and there was further increased dissolution as indicated by the buildup of more gas bubbles around the coupon.

After 2 minutes and 30 seconds of applying a negative current to the aluminum coupon, the application of current was stopped and not continued for the remainder of the reaction. The temperature increased to 34.5° C. and there was evidence of nitrogen oxide gases (NOx) forming, which were indicated by a yellowish color developing.

After 3 minutes and 30 seconds, the temperature increased to 64.6° C., indicating a rapid increase in dissolution rate. More NOx bubbles were formed.

After 4 minutes, the temperature increased to 76.5° C., indicating that the reaction rate was still increasing. Even more NOx bubbles were formed.

After 4 minutes and 36 seconds, the temperature increased to 86.7° C., indicating that the reaction rate was still increasing. Even more NOx bubbles were formed, as indicated by a brownish color developing.

After 5 minutes and 36 seconds, the temperature increased to 96.4° C., indicating that the reaction rate was still increasing. Even more NOx bubbles were formed, as indicated by a dark brown color.

As demonstrated by Example 2, a negative current can be applied for a relatively short period of time (in this case 2.5 minutes) and be stopped while the reaction continues to accelerate, driven by the exothermic nature of the dissolution reaction.

These and other modifications and variations to the present invention may be practiced by those of ordinary skill in the art, without departing from the spirit and scope of the present invention, which is more particularly set forth in the appended claims. In addition, it should be understood that aspects of the various embodiments may be interchanged both in whole or in part. Furthermore, those of ordinary skill in the art will appreciate that the foregoing description is by way of example only, and is not intended to limit the invention so further described in such appended claims.

What is claimed:

1. A process for dissolving a metal in an electrolytic acid medium using a catalyst, the process comprising:
applying a negative electrical current to the metal while the electrolytic acid medium is at a temperature below its boiling point to initiate a dissolution reaction;
stopping the application of the electrical current; and
allowing heat produced from the reaction to raise the temperature of the solution without the application of any external heat source.

2. The process of claim 1, wherein the metal comprises aluminum and/or an aluminum alloy.

3. The process of claim 1, wherein the metal comprises an aluminum-uranium alloy or uranium aluminide dispersed in a continuous aluminum phase core surrounded by an aluminum cladding.

4. The process of claim 1, wherein the electrolytic acid comprises nitric acid.

5. The process of claim 4, wherein the initial nitric acid concentration in the dissolution solution is from about 4 molar to about 15 molar.

6. The process of claim 1, wherein the catalyst comprises mercury.

7. The process of claim 6, wherein the mercury concentration in the dissolution solution is from about 0.0005 molar to about 0.02 molar.

8. The process of claim 1, wherein the process comprises electrically connecting the metal to a current source.

9. The process of claim 8, wherein the process comprises contacting the electrolytic acid medium with a counter electrode.

10. The process of claim 9, wherein the counter electrode comprises graphite.

11. The process of claim 1, wherein the reaction is initiated at a temperature of about 50° C. or less.

12. The process of claim 1, wherein the reaction is initiated at a temperature of about 30° C. or less.

13. The process of claim 1, wherein the negative current is applied for a time period from about 5 seconds to about 10 minutes before the application of the current is stopped.

14. The process of claim 1, wherein the metal is contained in a spent nuclear fuel assembly.

15. A process for dissolving aluminum comprising immersing the aluminum in a nitric acid solution containing greater than 0.001M mercury and applying an electrical current to the solution.

16. A process for dissolving aluminum during the recovery of a spent nuclear fuel, the process comprising:
immersing a material containing aluminum and a nuclear fuel in a nitric acid solution containing a mercury catalyst;
applying a negative electrical current to the material containing aluminum and a nuclear fuel while the temperature of the solution is below its boiling point;
stopping the application of the electrical current; and
allowing heat from the reaction to raise the temperature of the solution to its boiling point without the application of any external heat source.

17. The process of claim 16, wherein the initial nitric acid concentration in the dissolution solution is from about 4 molar to about 15 molar and the mercury concentration in the dissolution solution is from about 0.0005 molar to about 0.02 molar.

18. The process of claim 16, wherein the process comprises electrically connecting the metal to a current source and contacting the electrolytic acid medium with a counter electrode comprising graphite.

19. The process of claim 16, wherein the reaction is initiated at a temperature of about 30° C. and the negative current is applied for a time period from about 5 seconds to about 10 minutes before the application of the current is stopped.

20. A process as defined in claim 16, wherein the material containing aluminum and a nuclear fuel comprises an aluminum-uranium alloy or uranium aluminide dispersed in a continuous aluminum phase core surrounded by an aluminum cladding.
